(19) United States
(12) Patent Application Publication
(10) Pub. No.: US 2013/0331961 A1
(43) Pub. Date: Dec. 12, 2013

(54) DATA EXCHANGE SYSTEM PROVIDING FLEXIBLE AND ROBUST HANDLING OF UNITS OF MEASURE

(71) Applicant: Matthew John Mosley, Simpsonville, SC (US)

(72) Inventor: Matthew John Mosley, Simpsonville, SC (US)

(73) Assignee: GENERAL ELECTRIC COMPANY, Schenectady, NY (US)

(21) Appl. No.: 13/493,994

(22) Filed: Jun. 11, 2012

(51) Int. Cl. G05B 21/02

(52) U.S. Cl. 700/73

(57) ABSTRACT

A system and method for data exchange is provided. In one embodiment, a processor is configured to handle a data packet that represents a physical attribute related to monitoring and/or control of at least one equipment over a period of time. The processor is configured to exchange the data packet between a first device operating in a first unit of measure and a second device operating in a second unit of measure. The data packet includes a numerical value and a unit of measure suitable for the first device or the second device, wherein both the numerical value and the unit of measure may change with each data exchange.

### BACKGROUND OF THE INVENTION

The subject matter disclosed herein relates to industrial plants and industrial plant equipment, and more particularly, to a system and method of communicating data to and/or from industrial plants, industrial plant equipment, and related devices.

Power plants today are generally highly complex systems with many subsystems and components which may produce a large amount of data. Such data may be numerical data representing a certain physical attribute of the power plant that may be communicated to other power plants, control centers, and users. Often, the recipient of such data may convert the data to a different unit of measurement. In current systems, the numerical values of such physical attributes are generally separated from the units of measure. However, this may cause miscommunication of data, as numerical data may be received without the unit of measure, rendering it undefined. Further, in cases where unit conversions are made after receiving data, such error-prone, manual conversions may be an added source of error and confusion.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a processor configured to handle a data packet that represents a physical attribute related to monitoring and/or control of at least one equipment over a period of time. The processor is configured to exchange the data packet one or more times between a first device operating in a first unit of measure and a second device operating in a second unit of measure, and the data packet includes a numerical value and a unit of measure suitable for the first device or the second device, in which both the numerical value and the unit of measure selectively change with each data exchange.

In a second embodiment, a non-transitory machine readable medium includes code configured to handle a data packet that represents a physical attribute related to monitoring and/or control of at least one equipment over a period of time. The data packet is exchanged between a first device operating in a first unit of measure and a second device operating in a second unit of measure, and the data packet includes a numerical value and a unit of measure suitable for the first device or the second device, in which both the numerical value and the unit of measure selectively change with each data exchange.

In a third embodiment, a method includes handling a data packet that represents a physical attribute related to monitoring and/or control of at least one equipment over a period of time. The data packet is exchanged between a first device operating in a first unit of measure and a second device operating in a second unit of measure, and the data packet includes a numerical value and a unit of measure suitable for the first device or the second device. Both the numerical value and the unit of measure selectively change with each data exchange.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary power plant having a data exchange system, in accordance with embodiments of the present disclosure;

FIG. 2 is block diagram of an exemplary data exchange system having a central data exchange processor, in accordance with embodiments of the present disclosure;

FIG. 3 is a block diagram of an exemplary data exchange system having distributed data exchange processors, in accordance with embodiments of the present disclosure;

FIG. 4 is a simplified block diagram of an exemplary electronic device having a data exchange system, in accordance with embodiments of the present disclosure;

FIG. 5 is a flow chart depicting a process of supplementing raw data with a unit of measure and a physical attribute type to generate a data packet, in accordance with embodiments of the present disclosure;

FIG. 6 is a flow chart depicting a process of converting a first data packet into a second data packet, in accordance with embodiments of the present disclosure;

FIG. 7 is a flow chart depicting a process of performing an operation on a plurality of data packets, in accordance with embodiments of the present disclosure;

FIG. 8 is a diagram depicting communications in a data exchange system in which data conversion occurs in a central data exchange processor, in accordance with embodiments of the present disclosure;

FIG. 9 is a diagram depicting communications in a data exchange system in which data conversion occurs in a sending device, in accordance with embodiments of the present disclosure; and

FIG. 10 is a diagram depicting communications in a data exchange system in which data conversion occurs in a receiving device, in accordance with embodiments of the present disclosure.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are directed toward a data exchange system for various industrial equipment, such as power plants and power plant equipment. As discussed in detail below, the data exchange system may allow for the communication of numerical data between a plurality of power plants and power plant equipment in which the numerical data contains not only a numerical value, but also a unit of measure as well as a physical attribute type. Although discussed in context of power plants and associated equipment, the discussed embodiments may be used in a variety of industrial systems, such as industrial control and/or monitoring systems, industrial automation systems, and so forth. For example, the discussed embodiments may be configured to exchange data between turbine systems (e.g., gas, water, wind, steam, or nuclear turbine systems), gasification systems, gas treatment systems, power generation systems, power distribution systems, or any other plant systems. The data exchange system may also allow for automatic conversion of units of measure depending on the desired unit of measure of the numerical data. In general, a sending power plant may communicate a certain numerical data to a receiving power plant or equipment. The sending power plant and the receiving power plant may utilize different units of measure for the same data. As discussed herein, the physical attribute type may generally refer to the category or nature of data related to monitoring and/or control of equipment, such temperature, pressure, flow rate, velocity, torque, weight, volume, mass, etc. In contrast, the unit of measure may include multiple options for each attribute type. The data exchange system may allow the data to be sent with a unit of measure and attribute attached to the numerical value of the data, and automatically converts the data to be expressed in the unit of measure desired at the receiving power plant. For example, a power plant in the United States may collect numerical data in Standard units. This data, when communicated to a power plant or control center in Europe, may be automatically converted to Metric units of measure. This may reduce the miscommunication of numerical data as a unit of measure is always attached to a numerical value, and the need for error-prone manual unit conversion may be removed. Such automatic conversion may be applied in real-time and continuously to a stream of monitoring data (e.g., as it is acquired from sensors, equipment, etc.). It may also be used in association with industrial control systems having 2, 3, 4, 5, or more levels of redundancy, e.g., a dual-redundant control, a triple redundant controller, etc. As will be further discussed below, the data exchange system may include several different embodiments, and be implemented as a build in component of a power plant or power plant equipment or as a retro-fit kit for use with existing power plants and power plant equipment.

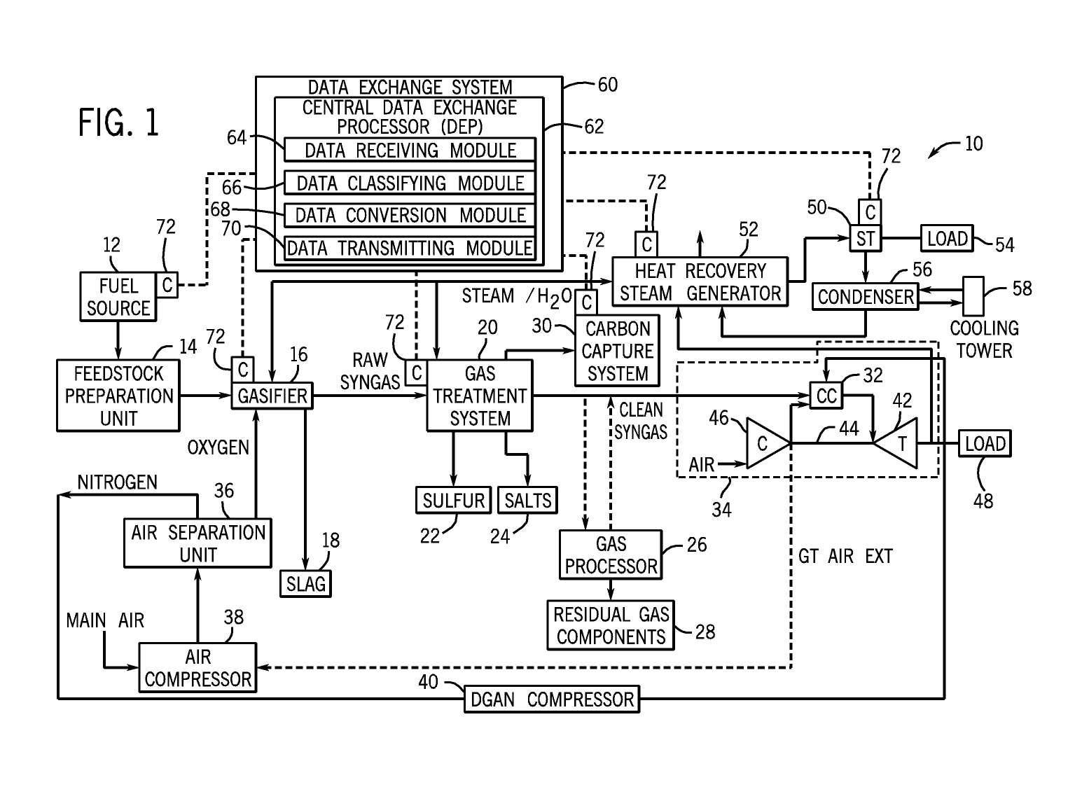

FIG. 1 is a block diagram of an exemplary power plant 10 having a data exchange system 60 configured to provide robust handing of numerical data. As illustrated in FIG. 1, the power plant 10 is powered by a fuel source 12, such as a solid feed, which is used to generate a syngas. The fuel source 12 may include coal, petroleum coke, biomass, wood-based materials, agricultural wastes, tars, coke oven gas and asphalt, or other carbon containing items. The solid fuel of the fuel source 12 may be passed to a feedstock preparation unit 14. The feedstock preparation unit 14 may, for example, resize or reshape the fuel source 12 by chopping, crushing, milling, shredding, pulverizing, briquetting, or palletizing the fuel source 12 to generate feedstock. Additionally, water, or other suitable liquids, may be added to the fuel source 12 in the feedstock preparation unit 14 to create slurry feedstock. In other embodiments, no liquid is added to the fuel source 12, thus yielding dry feedstock. The feedstock may be passed to a gasifier 16 from the feedstock preparation unit 14. The gasifier 16 may convert the feedstock into a combination of carbon monoxide, carbon dioxide, water, and hydrogen, e.g., syngas. This conversion may be accomplished by subjecting the feedstock to a controlled amount of steam and oxygen at elevated pressures. The gasification process may include the feedstock undergoing a pyrolysis process, whereby the feedstock is heated, generating a solid, e.g., char, and residue gases, e.g., carbon monoxide, and hydrogen.

A combustion process may then occur in the gasifier 16. The combustion may include introducing oxygen to the char and residue gases. The char and residue gases may react with the oxygen to form carbon dioxide and carbon monoxide, which provides heat for the subsequent gasification reactions. Next, steam may be introduced into the gasifier 16 during a gasification step. The char may react with the carbon dioxide and steam to produce carbon monoxide and hydrogen at temperatures ranging from approximately 800° C. to 1400° C. In essence, the gasifier utilizes steam and oxygen to allow some of the feedstock to be “burned” to produce carbon monoxide and energy, which drives a second reaction that converts further feedstock to hydrogen and additional carbon dioxide. In this way, a resultant gas is manufactured by the gasifier 16. This resultant gas may be termed raw syngas. The gasifier 16 may also generate waste, such as slag 18, which may be a wet ash material. This slag 18 may be removed from the gasifier 16 and disposed of, for example, as road base or as another building material. The raw syngas from the gasifier 16 may then be cleaned in a gas treatment system 20. For example, the gas treatment system 20 may perform separate sulfur 22 and salts 24 from the cooled raw (e.g., non-scrubbed) syngas. Subsequently, the gas from the gas treatment system 20 may include clean (e.g., scrubbed) syngas. In certain embodiments, a gas processor 26 may be utilized to remove residual gas components 28 from the clean (e.g., scrubbed) syngas such as, ammonia, methanol, or any residual chemicals.

In addition, in certain embodiments, a carbon capture system 30 may remove and process the carbonaceous gas (e.g., carbon dioxide that is approximately 80-100 percent pure by volume) contained in the syngas. The scrubbed syngas may be then transmitted to a combustor 32, e.g., a combustion chamber, of a gas turbine engine 34 as combustible fuel.

The power plant 10 may further include an air separation unit (ASU) 36. The ASU 36 may operate to separate air into component gases by, for example, distillation techniques. The ASU 36 may separate oxygen from the air supplied to it from an ASU compressor 38, and the ASU 36 may transfer the separated oxygen to the gasifier 16. Additionally, the ASU 36 may transmit separated nitrogen to a diluent gaseous nitrogen (DGAN) compressor 40. The DGAN compressor 40 may compress the nitrogen received from the ASU 36 at least to pressure levels equal to those in the combustor 32 of the gas turbine engine 34, for proper injection to happen into the combustor chamber. Thus, once the DGAN compressor 40 has adequately compressed the nitrogen to a proper level, the DGAN compressor 40 may transmit the compressed nitrogen to the combustor 32 of the gas turbine engine 34. The nitrogen may be used as a diluent to facilitate control of emissions, for example.

The gas turbine engine 34 may include a turbine 42, a drive shaft 44 and a compressor 46, as well as the combustor 32. The combustor 32 may receive fuel, such as syngas, which may be injected under pressure from fuel nozzles. This fuel may be mixed with compressed air as well as compressed nitrogen from the DGAN compressor 40, and combusted within combustor 32. This combustion may create hot pressurized combustion gases.

The combustor 32 may direct the combustion gases towards an inlet of the turbine 42. As the combustion gases from the combustor 32 pass through the turbine 42, the combustion gases may force turbine blades in the turbine 42 to rotate the drive shaft 44 along an axis of the gas turbine engine 34. As illustrated, drive shaft 44 is connected to various components of the gas turbine engine 34, including the compressor 46. The drive shaft 44 may connect the turbine 42 to the compressor 46 to form a rotor. The compressor 46 may include blades coupled to the drive shaft 44. Thus, rotation of turbine blades in the turbine 42 causes the drive shaft 44 connecting the turbine 42 to the compressor 46 to rotate blades within the compressor 46. This rotation of blades in the compressor 46 may cause the compressor 46 to compress air received via an air intake in the compressor 46. The compressed air may then be fed to the combustor 32 and mixed with fuel and compressed nitrogen to allow for higher efficiency combustion. The drive shaft 44 may also be connected to a first load 48, which may be a stationary load, such as an electrical generator for producing electrical power, for example, in a power plant. Indeed, the first load 48 may be any suitable device that is powered by the rotational output of the gas turbine engine 34.

The power plant 10 also may include a steam turbine engine 50 and a heat recovery steam generation (HRSG) system 52. The steam turbine engine 50 may drive a second load 54. The second load 54 may also be an electrical generator for generating electrical power. However, both the first and second loads 48, 54 may be other types of loads capable of being driven by the gas turbine engine 34 and steam turbine engine 50, respectively.

Additionally, heated exhaust gas from the gas turbine engine 34 may be transported into the HRSG 52 and used to heat water and produce steam used to power the steam turbine engine 50. Exhaust from, for example, a low-pressure section of the steam turbine engine 50 may be directed into a condenser 56. The condenser 56 may utilize a cooling tower 58 to exchange heated water for cooled water. The cooling tower 58 acts to provide cool water to the condenser 56 to aid in condensing the steam transmitted to the condenser 56 from the steam turbine engine 50. Condensate from the condenser 56 may, in turn, be directed into the HRSG 52. Again, exhaust from the gas turbine engine 34 may also be directed into the HRSG 52 to heat the water from the condenser 56 and produce steam.

The illustrated power plant 10 of FIG. 1 includes a variety of different subsystems and components that perform different tasks, such as the fuel source 12, the gasifier 16, the gas treatment system 20, the carbon capture system 30, the heat recovery steam generator 52, the steam turbine engine 50, and so forth. Each of these components may be monitored by a controller 72 that collects data regarding conditions and attributes of the respective component. For example, data may be collected regarding volume, density, temperature, pressure, material composition, flow rate, torque, power, clearance, vibration, and so forth

As previously mentioned, the power plant 10 may also include the data exchange system 60. The data exchange system 60 may include a central data exchange processor 62, which may further include a data receiving module 64, a data classifying module 66, a data conversion module 68, and a data transmitting module 70. The data receiving module 64 may be configured to receive incoming data from the controllers 72 or other source such as a user input on a device. The received data may be raw data that may not include a unit of measure or an attribute type. The data classifying module 66 may be configured to assign the appropriate unit of measure and/or the appropriate attribute type to each numerical value in the data, which transforms the raw data from the controllers 72 into a data packet, specifically, a first data packet. The data packet may include the numerical value of the data as well as the unit of measure and/or attribute type. In certain embodiments, information regarding the appropriate unit of measure and attribute type may be communicated to the data exchange system by the controllers 72 before, during, or after the communication of the data itself. In certain embodiments, information regarding the appropriate unit of measure and attribute type may already be stored in the data exchange system 60. Additionally, the data exchange system 60 may be able to identify the received data or the controller 72 from which the data was sent and apply the corresponding unit of measure and/or attribute type for that data. The data conversion module 70 may be configured to convert the first data packet to an equivalent second data packet. The second data packet includes measured data that is generally physically equivalent to that of the first data packet in that both the first and second data packets are expressions of the same data value in different units of measure. However, in some cases, the first and second data packets may have the same unit of measure. The data conversion module 70 may include or access pre-programmed unit conversion information such as mathematical conversions, functions, mathematical models, and so forth. Such information may be organized in a format such as a table, list, etc., which allows the data conversion module 70 to perform the appropriate mathematical calculations to arrive at correct numerical value of the second data packet. The correct conversion may be preprogrammed in the data conversion module 70 or it may be determined based on the requesting device or another control source such as a user device. Further, the appropriate unit of measure and attribute type is attached to the numerical value to form the second data packet. The data transmitting module 70 may then send the second data packet to a destination, which may include a requesting device, another controller 72, another power plant 10, user device, industrial machine (e.g., turbine system, gasification system, power generation system, or industrial automation system), and so forth, and any combination thereof.

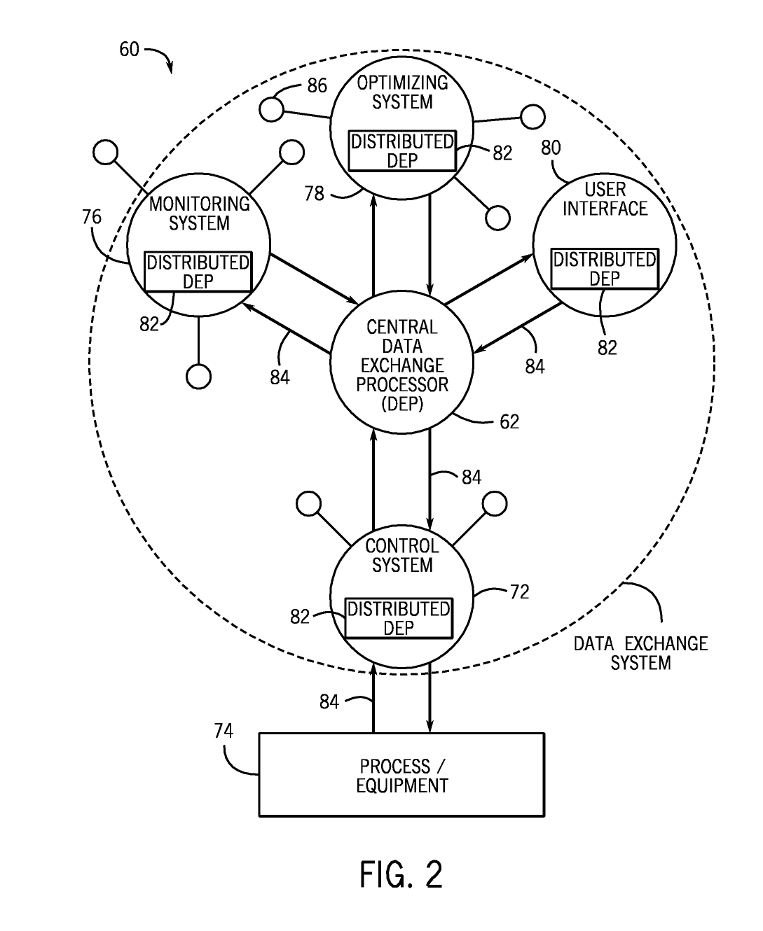

An embodiment of the data exchange system 60 is illustrated in more detail in FIG. 2. The illustrated embodiment includes the central data exchange processor (DEP) 62, which is coupled to the controller or control system 72 of a component 74 such as a process or equipment. For example, the component 74 may include a gas turbine engine, a steam turbine, a wind turbine, a hydro turbine, a gasifier, a gas treatment unit (e.g., an acid gas removal unit or carbon capture unit), an electrical generator, a compressor, a motor, a boiler, a furnace, a motorized machine, an air separation unit, or any combination thereof. Each of these components 74 may receive and transmit data, such as control data, sensor data, firmware data, calibration data, historical data, and so forth. The central DEP 62 may also be coupled to a plurality of subsystems such as a monitoring system 76, an optimizing system 78, and a user interface 80. Each or a subset of these subsystems, as well as the control system 72 may include a distributed DEP 82. The distributed DEP 82 may be capable of performing the same functions or a subset of the functions of the central DEP 62, including sending, receiving, and converting data. It should be noted that the monitoring system 76, the optimizing system 78, and the user interface 80 are examples of subsystems and/or plant peripherals that may be interchangeable with other systems that may not be described herein for brevity considerations. In certain embodiments, the subsystems may be coupled to one or more subcomponents 86 which it may further communicate data to and/or collect data from.

The central DEP 62 may configured to communicate with the control system 72, the monitoring system 76, the optimizing system 78, and the user interface 80 via bidirectional communication channels 84. The control system 72 may also be configured to communicate with the component 74 via the bidirectional communication channel 84, which allows for sending and receiving of data. The control system 72 may also send control commands to the component 74 and the component 74 may send data to the control system 72. In certain embodiments, the data may include a certain measured numerical parameter of the component 74, such as pressure, flow rate, volume, temperature, vibration, torque, power, material composition, clearance, speed, and so forth. Such data may be transmitted from the component 74 to the control system 72 in a raw form, which may include only a numerical value or a continuous stream of raw numerical values that correspond to the measured value with respect to a time interval. For example, the component 74 may include a heat recovery steam generator (HSRG). The HSRG may be instrumented with a temperature sensor which continuously senses the temperature of a segment of the HRSG. The sensed temperature may be transmitted to the control system 72, where it may be processed. The temperature may be sensed once upon receiving a command from the control system 74, or it may be sensed continuously or on a regular time interval. Generally, the control system 72 receives the temperature data in a raw form, which includes only a numerical value. In certain embodiments, the raw form may include a numerical value that is the actual temperature sensed. In certain embodiments, the raw form may include a voltage or other data signal that correlates to a temperature. A processor in the control system 72 may receive such voltage or other data and translate the voltage or other data into the actual measured temperature based on preprogrammed logic that maps voltage and other data signals to corresponding temperature values.

The distributed DEP 82 may receive the numerical value of the raw data and supplement the numerical value with a unit of measure and, in some embodiments, an attribute type. The type of unit of measure that is supplemented with the numerical value may be preset or selected by a user. The distributed DEP may recognize the source of the raw data, such as the type or identity of the sensor through which the raw data was collected, such that the distributed DEP 82 may recognize the attribute type. For example, the distributed DEP 82 may recognize that the raw data in the above example is a temperature data. In some embodiments, a user may manually input the attribute type of the raw data. Thus, the possible units of measure that may be assigned to the raw data may be limited to only those that are measures of the appropriate attribute type. In the given example, the possible units of measure that may be assigned to the raw temperature data may be measures of temperature, (e.g., Fahrenheit, Celsius, Kelvin). As mentioned, the selection of the type of unit of measure that is supplemented with the raw data may be done automatically according to presets or it may be selected by the user. In certain embodiments, when the unit of measure is to be selected to the user, the user may be presented with unit of measure options that are appropriate units of measure for the raw data given its attribute type. In the above example, the user may be presented with a unit of measure selector (e.g., drop down menu, radial selector, buttons) that includes the choices: Fahrenheit, Celsius, and Kelvin. Generally, the user may be blocked from selecting a unit of measure that is not an appropriate unit of measure for the raw data to be supplemented with. For example, the user may be blocked from selecting Meters or PSI for raw data that represents temperature.

Generally, the distributed DEP 82 may supplement the numerical data received from the component 74 or control system 72 with a unit of measure and an attribute type. Thus, the distributed DEP generates a data packet, which contains a numerical value, a unit of measure of the numerical value, and an attribute type of the numeric value. It should be noted that in certain embodiments, the control system 72 may not include a distributed DEP 82, and/or the abovementioned transformation of raw data into data packet may done in the Central DEP 62.

In certain embodiments, the distributed DEP 82 may transmit the data packet to the central DEP 62 as a data packet signal. As mentioned, the central DEP 62 may also be communicatively coupled to one or more subsystems, such as the monitoring system 76, the optimizing system 78, and the user interface 80. One or more of the subsystems may be used to access or view certain data collected from the component 72. For example, the user interface 80 may be configured to display data or parameter values collected from the component 72, e.g., pressure, flow rate, temperature, torque, power, speed, vibration, or volume. In certain situations, the user interface 80 may be configured to display the data as a certain unit of measure. For example, the user interface 80 may be configured to display the temperature in degrees Celsius. This setting may be preset or selected by the user. The control system 72, which initially receives the temperature data from the component 74, may be programmed to present the sensed temperature in degrees Fahrenheit. As discussed, the distributed DEP 82 of the control system 72 generates the data packet, which may include, for example:

[102 |Degrees Fahrenheit|Temperature]

The central DEP 62, which may be configured to receive the data packet from the control system 72, may also receive a request from the user interface 80 to send the data packet to the user interface 80, for example. The data packet sent from the control system 72 to the central DEP 62 may be referred to as a first data packet (e.g., first value, attribute type, and unit of measure), and the data packet requested by, and/or sent to, the user interface 80 (or any receiving subsystem) may be referred to as a second data packet (e.g., second value, attribute type, and unit of measure). In certain embodiments, the receiving system may be another industrial plant or component such as a power plant or component. Generally, the first data packet and the second data packet are both representations of the same data value collected at the component 74. In certain embodiments, the first data packet and the second data packet may be the same. However, in certain embodiments, the second data packet may include a different unit of measure. As such, in one or more embodiments, the central DEP 62 may be configured to convert the first data packet into the second data packet. This may be performed by accessing a conversion function, model, table, or other data, which defines conversion relationships between two or more units of measure. Given that the first data packet includes the unit of measure that its numerical value is based on, as well as the attribute type, and the second data packet includes the desired unit of measure, the mathematical relationship between the unit of measure of the first data packet and the unit of measure of the second data packet may be found and applied to the numerical value of the first data packet to obtain the numerical value of the second data packet. The user of the user interface 80 (or other subsystem) may select the unit of measure for presentation of the raw data collected from the component. However, in certain embodiments, the selection of the unit of measure may be limited to those appropriate for the attribute type.

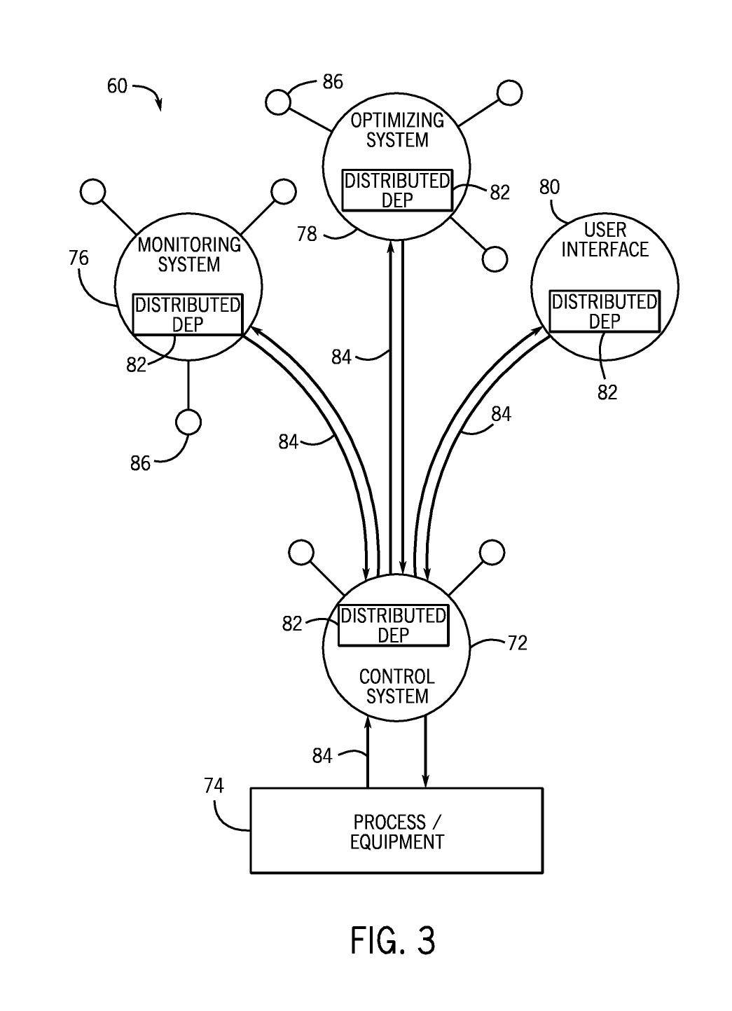

FIG. 3 illustrates an embodiment of the data exchange system 60 without a central DEP 62. Rather, the embodiment may include distributed DEP's 82 coupled to the control system 72 and other subsystems (76, 78, 80). In this embodiment, the conversion between the first data packet and the second data packet may be performed by either the distributed DEP 82 of the control system 72 or the distributed DEP 82 of the other subsystems (76, 78, 80). For example, the distributed DEP 82 of the control system 72 may receive a request from a requesting device, such as the monitoring system 76, for certain data. The distributed DEP 82 of the control system 72 may not only generate the first data packet, but may also convert the first data packet (e.g., first value, attribute type, and unit of measure) into the requested second data packet (e.g., second value, attribute type, and unit of measure) before transmitting to the monitoring system 76. Alternatively, the control system 72 may be configured to send the first data packet to the monitoring system 76 without converting the first data packet into the second data packet. Accordingly, the monitoring system (or receiving system) may be configured to convert the received first data packet into the desired second data packet. Again, the data received from the component 74 may be a raw data (e.g., numerical value) without any other information about the data, such as, an attribute type or unit of measure. Thus, the raw data may be supplemented and/or converted by the distributed DEPs 82 to include an appropriate unit of measure and attribute type, thereby facilitating use of the data across different platforms that may otherwise use incompatible units of measure.

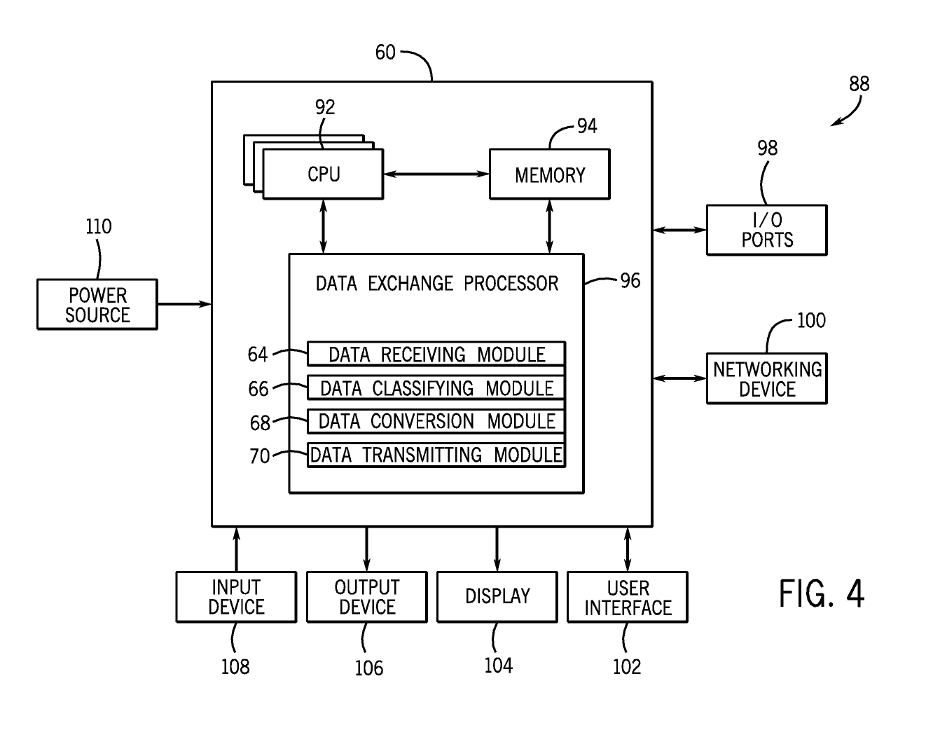

FIG. 4 is a representative block diagram of an electronic device 88 that may include a data exchange system 60. The electronic device 88 may include a computer, a control device, a mobile device, etc. The electronic device may include one or more CPUs 92, a memory 94, and a data exchange processor 96, which includes the data receiving module 64, the data classifying module 66, the data conversion module 68, and the data transmitting module 70. In certain embodiments, the electronic device 88 may be an industrial controller, such as a redundant controller with 2, 3, 4, 5, or more levels of redundancy. Thus, the electronic device 88 may include 2, 3, 4, 5, or more CPUs 92 and/or data exchange processors 96. The data receiving module 64 is configured to receive incoming data from the control system 72 or other subsystems. The received data may be raw data that is only a numerical value, but may not include a unit of measure or an attribute type. The data classifying module 66 is configured to assign an appropriate unit of measure and/or the appropriate attribute type to each numerical value in the data, which converts the raw data from the controllers into the data packet, specifically, the first data packet. In certain embodiments, information regarding the appropriate unit of measure and attribute type may be communicated to the data exchange system 60 by the control system 72 before, during, or after the communication of the data itself. Conversions from a first data packet to a second data packet may be made in real-time (or near real-time) as data is collected from sensors, or from historical data that may have been previously collected. In other words, the data may be continuously or periodically acquired, converted (e.g., supplemented), and transmitted between different systems and components in real-time (or near real-time), or after a substantial delay. In certain other embodiments, information regarding the appropriate unit of measure and attribute type may already be stored in the data exchange system 60. Additionally, as discussed, the data exchange system 60 may be able to identify the received data or the component 74 from which the data was sent and apply the corresponding unit of measure and/or attribute type for that data.

The data conversion module 70 may be configured to convert the first data packet (e.g., first value, attribute type, and unit of measure) to an equivalent second data packet (e.g., second value, attribute type, and unit of measure). The second data packet is generally physically equivalent to the first data packet in that both the first and second data packets are expressions of the same data in different units of measure. However, in some cases, the first and second data packets may have the same unit of measure and there may not be any conversion. The data conversion module 70 may include or access pre-programmed unit conversion information, such as a table, list, conversion function, model, or equation, which allows the data conversion module 70 to perform the appropriate mathematical calculations to arrive at a correct numerical value of the second data packet. The conversion information as well as the accompanying logic may be stored in the memory 94 as non-transitory machine readable medium. Further, the appropriate unit of measure and attribute type is attached to the numerical value to form the second data packet. The data transmitting module 70 may send the second data packet to a destination, which may include another subsystem, another power plant 10, user device, so forth, and any combination thereof.

The electronic device 88 may also include one or more I/O ports 98, which allow the electronic device to be coupled to other devices such as external memory, peripheral devices, another device containing a data exchange system, and so forth. The electronic device 88 may also include a networking device 100, which enables the electronic device 88 to communicate with other devices. The network device 24 may allow the electronic device 88 to communicate over a network, such as a Local Area Network (LAN), Wide Area Network (WAN), cellular network, or the Internet. The electronic device may further include a user interface 102, a display 104, an output device 106, an input device 108, and a power source 110. The user interface 102, which may include a graphical user interface, may allow the user to interact with the electronic device 88, such as inputting commands and/or selections and viewing information. The display 104 may be configured to display information to the user, such as data, notifications, options, and so forth. In certain embodiments, the user interface 102 and the display 104 may be combined, as in a touch screen display. The input device 108 may be configured to physically receive data signals from components 72 or subsystems 74 and send the data signals to the data exchange processor 96. The output device 106 may output certain data such as a first or second data packet to a component 72, a subsystem 74, or another electronic device 88. The power source 110 may include one or more batteries, AC power, such as that provided by an electrical outlet, and so forth.

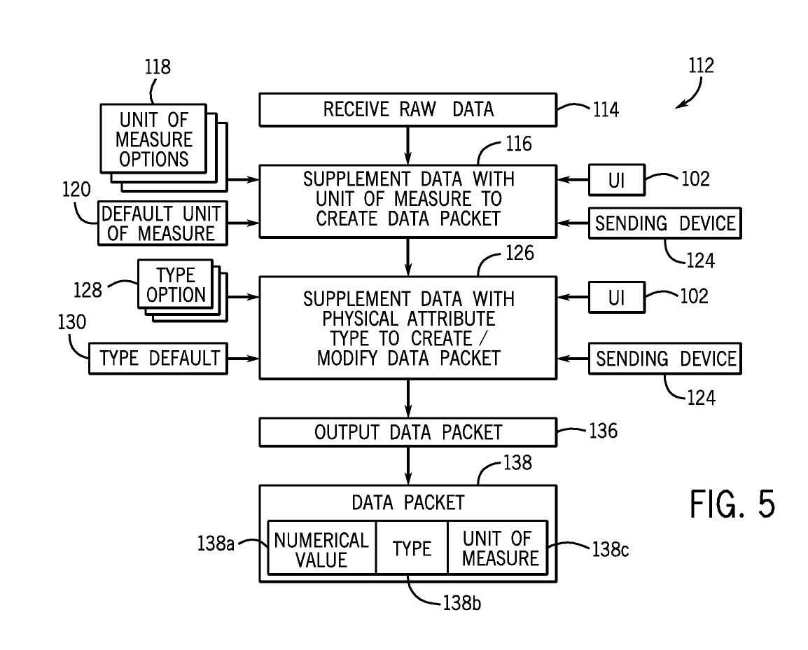

FIG. 5 illustrates a computer-implemented process 112 for converting raw data into a data packet. The process 112 may execute code or instructions stored on a non-transitory, tangible, machine readable medium, such as memory or a controller (e.g., a dual or triple redundant industrial controller). The data exchange system 60 may be configured to receive (block 114) raw data, generally from a sensor, component 74, or subsystem. Such data may be received in real-time (or near real-time) during operation of an industrial system, such as a power plant, equipment, industrial control system, or the like. Examples may include sensor data acquired continuously or periodically from various equipment. As mentioned, the raw data may include only a numerical value and may not include a unit of measure or an attribute type. The data exchange system 60 may then supplement (block 116) the raw data with an appropriate unit of measure to create the data packet. As mentioned, this may be performed continuously in real-time as raw data is generated by sensors. In doing so, certain appropriate units of measure options 118 may be applied to the raw data. There may also be a default unit of measure 120 that may also be applied. Additionally, the supplement unit of measure may be inputted by the user via the user interface 102. In certain embodiments, the unit of measure may also be determined by an input from a sending device 124, such a component 74 or subsystem where the raw data originated. The data packet may include not only the numerical value of the raw data, but also an appropriate unit of measure. It should be noted that the numerical value of the data may change depending on the unit of measure. The data exchange system 60 may further supplement (block 126) the data with a physical attribute type, which defines an attribute type of the data packet. Like the unit of measure supplementing step, the physical attribute that is to be supplemented may originate from different sources, including a list of attribute type options 128, a preset default attribute type 130, a user input from the user interface 102, or as selected by the sending device 124 where the raw data originated. It should be noted that the steps of supplementing unit of measure and supplementing physical attribute type may be interchangeable, such that the physical attribute may be supplemented before the unit of measure is supplemented, or vice versa. The data exchange system 60 may then output the data packet. In this embodiment, the data packet 138 may include a numerical value 138a, an attribute type 138b, and a unit of measure 138c. In certain embodiments, either the supplement unit of measure step or the supplement attribute type step may be bypassed, such that the outputted data packet includes the numerical value 138a, and either the attribute type 138b or the unit of measure 138c. As discussed, the attribute type may generally refer to the category or nature of the data, such temperature, pressure, flow rate, velocity, torque, weight, volume, mass, etc. In contrast, the unit of measure may include multiple options for each attribute type.

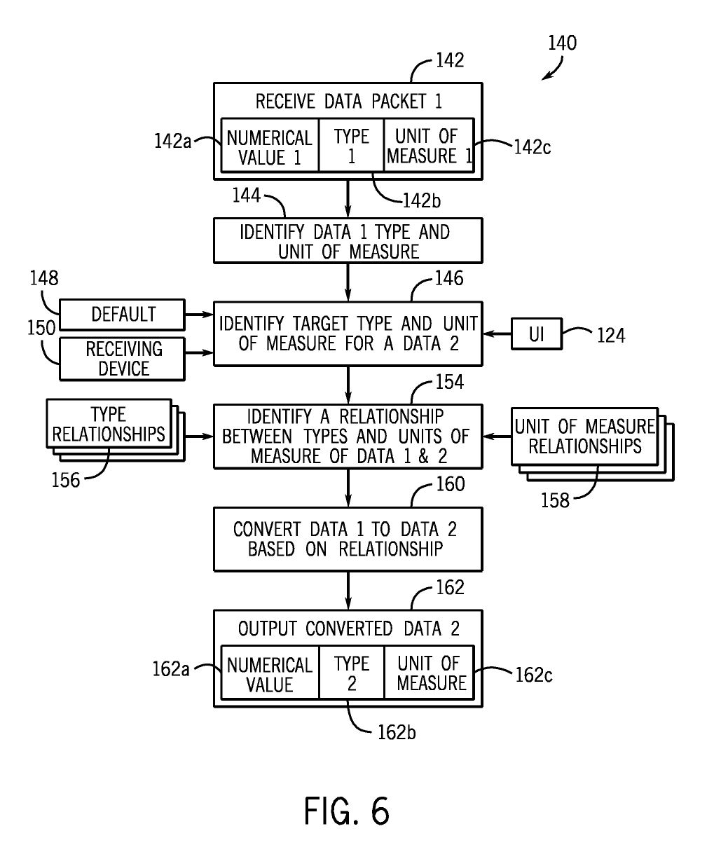

FIG. 6 illustrates a computer-implemented process 140 for converting a first data packet into a second data packet. The process 112 may execute code or instructions stored on a non-transitory, tangible, machine readable medium, such as memory or a controller (e.g., a dual or triple redundant industrial controller). The data exchange system 60 may receive (block 142) the first data packet, which may include a first numerical value 142a, a first attribute type 142b, and a first unit of measure 142c. Such data may be received in real-time (or near real-time) during operation of an industrial system, such as a power plant, equipment, industrial control system, or the like. Examples may include sensor data acquired continuously or periodically from various equipment. The data exchange system 60 may then identify (block 144) the first attribute type 142b and the first unit of measure 142c. The data exchange system may also identify (block 146) targets for a second attribute type and a second unit of measure of the second data packet. The targets for the second attribute type and second unit of measure may originate from a default setting 148, a receiving device 150 (e.g., intended recipient, requesting device, or both), or a user selection via a user interface 124. The data exchange system 60 may also identify a relationship between the first attribute type and the second attribute type, and between the first unit of measure and the second unit of measure. For example, the data exchange system 60 may determine that the first attribute type and the second attribute type are consistent to enable a simple conversion from one unit of measure to another. If the types are different at block 154, then the process 140 may employ one or more type relationships 156 to correlate and/or enable conversion of the data between the first and second attribute types, and also one or more unit of measure relationships 158 to enable conversion of the data between the first and second units of measure. If the types are the same, then the process 140 may employ one or more unit of measure relationships 158 to identify (block 154) the mathematical relationship between the first unit of measure and the second unit of measure. The data exchange system 60 may then convert (block 160) the first data packet into the second supplemented according to the identified relationships between the first and second attribute types and the first and the second units of measure. The data exchange system 60 may then output (block 162) the second data packet, which includes a second numerical value 162a, a second attribute type 162b, which may be equal to or different from the first attribute time 142b, and the second unit of measure 162c.

In additional to converting a first data packet into a second data packet, the data exchange system 60 may also be configured to perform a calculation in which two types of data packet may be combined to calculate a third data packet. For example, in this embodiment, the attribute type of the first data packet may be a measure of area and the attribute type of the second data packet may be a measure of height. The desired attribute type of the third data packet may a measure of volume. Thus, the data exchange system 60 may perform a mathematical operation involving the first and second data packet to achieve the third data packet.

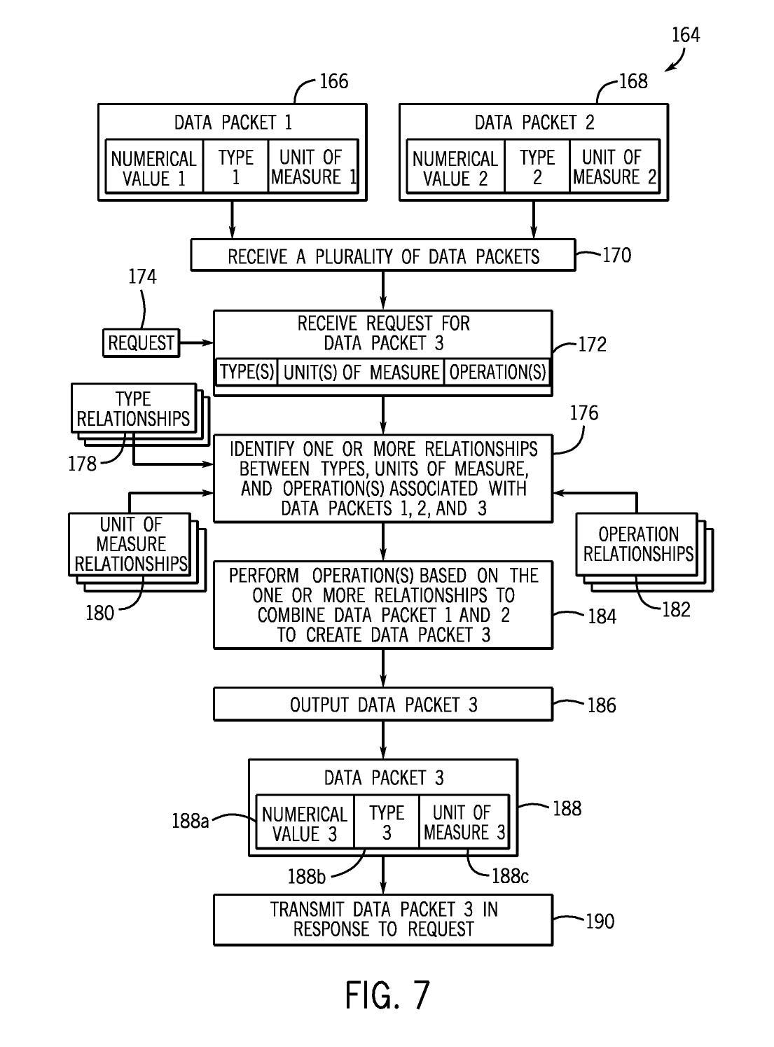

FIG. 7 illustrates a process 164 for generating a third data packet from a plurality of data, such as the first and second data packets, in which the third data packet is generally a mathematical combination or function of the first and second data packets. The process 112 may execute code or instructions stored on a non-transitory, tangible, machine readable medium, such as memory or a controller (e.g., a dual or triple redundant industrial controller). In the present embodiment, the data exchange system 60 may receive (block 170) a plurality of data packets, such as a first data packets 166 (e.g., first value, attribute type, and unit of measure) and a second data packet 168 (e.g., second value, attribute, and unit of measure). Such data may be received in real-time (or near real-time) during operation of an industrial system, such as a power plant, equipment, industrial control system, or the like. Examples may include sensor data acquired continuously or periodically from various equipment. The data exchange system 60 may also receive (block 172) a request 174 for a third data packet (e.g., third value, attribute type, and unit of measure). The request 174 may include an attribute type, a unit of measure, and an operation. The attribute type and unit of measure refer to the attribute type and unit of measure desired for the third data packet. The operation refers to the desired mathematical operation to be performed as a function of the first and second data packets. For example, if the third data packet is to be the first data packet multiplied by the second data packet, the operation may be multiplication. The data exchange system 60 may identify (block 176) one or more relationships between attribute types, units of measure, and operations associated with data packets 1, 2, and 3 by accessing a module containing attribute type relationships 178, unit of measure relationships 180, and operation relationships 182. The data exchange system 60 may then perform (block 184) the appropriate operations to mathematically combine or transform the first data packet and the second data packet into a third data packet. The data exchange system 60 may then output (block 186) the third data packet 188, which may includes a third numerical value 188a, a third attribute type 188b, which may be different from the first and second attribute types, and a third unit of measure 188c. The data exchange system may then transmit (block 190) the third data packet 188 in response to the request 174.

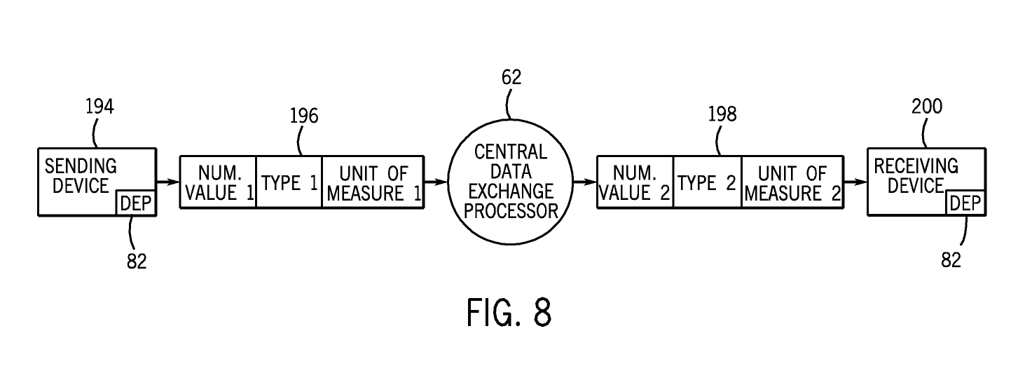

FIGS. 8-10 are block diagrams illustrating embodiments of the communication and conversion of data packets from a sending device 194 to a receiving device 200. FIG. 8 illustrates an embodiment which includes the central DEP 62 discussed in FIG. 2. In the embodiment, a first data packet 196 is transmitted from the sending device 194 to the central DEP 62, which converts the first data packet 196 to a second data packet 198 (e.g., second value, attribute type, and unit of measure). The second data packet 198 may then transmitted from the central DEP 62 to the receiving device 200.

The sending device 194 may acquire or generate data continuously or periodically in real-time (or near real-time) during operation of the industrial system. Raw data may also be continuously or periodically supplemented in real-time (or near real-time) to generate the first data packet 196, which may then be transmitted to the central DEP 62 for further conversion in real-time (or near real-time). In certain embodiments, raw data collected by the sensors may be stored and supplemented and/or converted at a later time upon instruction from a user, rather than in real-time.

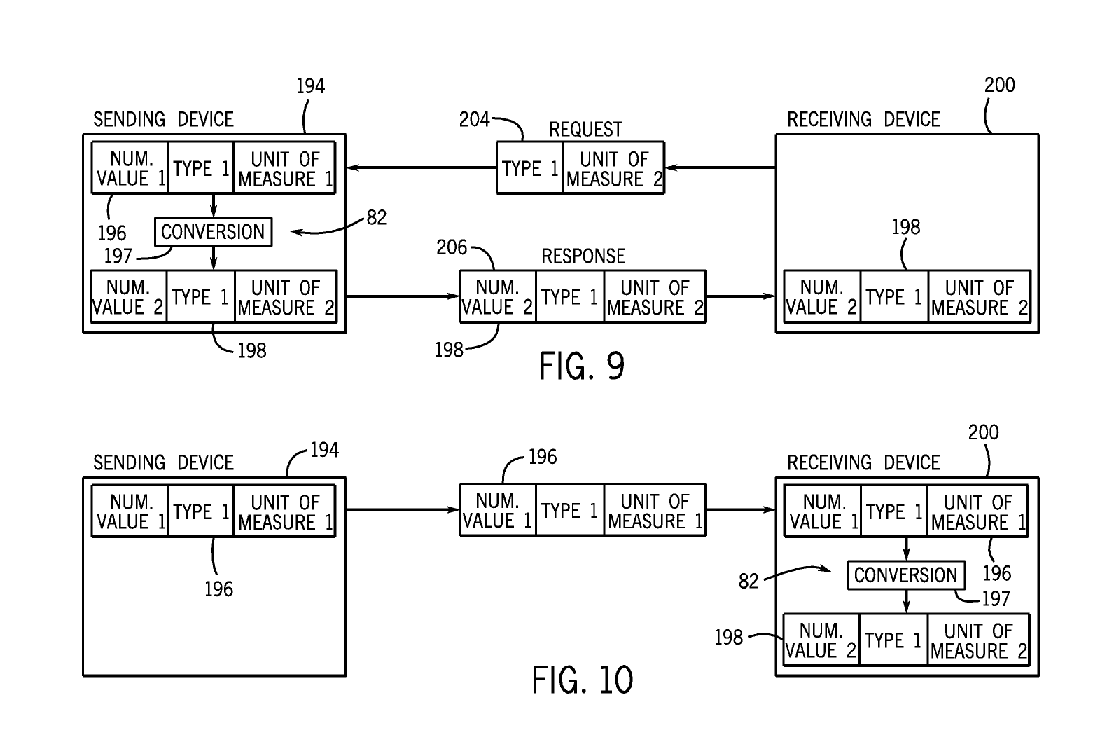

FIGS. 9-10 illustrate embodiments of the data exchange system 60 which may not include a central DEP 62. Rather, the functions of the central DEP 62 may generally be carried out in either the distributed DEP 82 of the sending device 194, the receiving device 200, or both. In the embodiment illustrated in FIG. 9, the sending device 194 may have a first data packet 196, which the distributed DEP 82 may convert (block 197) to a second data packet 198 according to a request 204 sent from the receiving device 200 to the sending device 194. The request 204 may include the attribute type and desired unit of measure of the second data packet 198. The sending device 194 may send a response 206 to the receiving device 200, wherein the response 206 includes the second data packet 198. In the embodiment illustrated in FIG. 10, the sending device 194, which has the first data packet 196, may send the first data packet 196 to the receiving device 200, and the receiving device 200 may be configured to receive the first data packet 196 and convert (block 197) the first data packet 196 into the second data packet 198. As such, in certain embodiments, DEP functions such as receiving data, classifying data, converting data, and transmitting data may be carried out by the central DEP 62 or any corresponding distributed DEP 82.

Technical effects of the invention include enhanced data communication between parts of an industrial plant, between two or more industrial plants, or between an industrial plant and another device or station. Numerical data, such as that obtained from sensors or instrumentation, may be communicated along with its unit of measure as well as physical attribute type. This may decrease data interpretation errors that may otherwise occur when numerical data is communicated without its unit of measure. The present techniques also facilitate robust conversion of numerical data between different units of measure. As such, components and industrial plants may communicate with each other without requiring conformity to a fixed set of units of measure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a processor configured to handle a data packet that represents a physical attribute related to monitoring and/or control of at least one equipment over a period of time, wherein the processor is configured to exchange the data packet one or more times between a first device operating in a first unit of measure and a second device operating in a second unit of measure, and the data packet includes a numerical value and a unit of measure suitable for the first device or the second device, wherein both the numerical value and the unit of measure selectively change with each data exchange.

2. The system of claim 1, wherein the data packet includes the numerical value, the unit of measure, and a physical attribute type suitable for the first device or the second device.

3. The system of claim 2, wherein the processor is configured to convert the data packet from a first data packet to a second data packet, wherein the first data packet comprises a first numerical value, the first unit of measure, and a first physical attribute type suitable for the first device, wherein the second data packet comprises a second numerical value, the second unit of measure, and a second physical attribute type suitable for the second device.

4. The system of claim 3, wherein the first physical attribute type and the second physical attribute type are the same as one another, and wherein the first unit of measure and the second unit of measure are different from one another.

5. The system of claim 3, wherein the processor is configured to perform a mathematical operation taking the first data packet as input and outputting the second data packet.

6. The system of claim 3, wherein the processor is disposed on at least one of the first device, the second device, a central device separate from the first and second devices, or any combination thereof.

7. The system of claim 2, wherein the processor is configured to receive a raw data that includes only a numerical value, and to generate the data packet to include the numerical value, the unit of measure, and the physical attribute type.

8. The system of claim 1, wherein the processor is configured to convert the data packet from a first data packet to a second data packet, wherein the first data packet comprises a first numerical value and the first unit of measure suitable for the first device, wherein the second data packet comprises a second numerical value and the second unit of measure suitable for the second device.

9. The system of claim 8, wherein the processor is disposed on at least one of the first device, the second device, the central device separate from the first and second devices, or any combination thereof.

10. The system of claim 1, wherein the processor is configured to receive a raw data that includes only a numerical value, and to generate the data packet to include the numerical value and the unit of measure.

11. The system of claim 1, wherein the processor is configured to exchange the data packet continuously or periodically between the first and second devices in response to continuous or periodic monitoring and/or control of the at least one equipment over the period of time.

12. The system of claim 1, wherein the at least one equipment comprises a gasifier, a turbine, a compressor, an air separation unit, a heat recovery steam generator, an electrical generator, a gas treatment system, or any combination thereof.

13. The system of claim 1, wherein the processor comprises a data exchange processor having a data receiving module, a data classifying module, a data conversion module, and a data transmitting module.

14. A non-transitory machine readable medium, comprising:
code configured to handle a data packet that represents a physical attribute related to monitoring and/or control of at least one equipment over a period of time, wherein the data packet is exchanged between a first device operating in a first unit of measure and a second device operating in a second unit of measure, and the data packet includes a numerical value and a unit of measure suitable for the first device or the second device, wherein both the numerical value and the unit of measure selectively change with each data exchange.

15. The non-transitory machine readable medium of claim 14, wherein the code comprises a data receiving module, a data classifying module, a data conversion module, and a data transmitting module, wherein the data classifying module is configured to receive a raw data that includes only a numerical value, and to generate the data packet to include the numerical value and the unit of measure, wherein the data conversion module is configured to convert the data packet from a first data packet to a second data packet, wherein the first data packet comprises a first numerical value and the first unit of measure suitable for the first device, and the second data packet comprises a second numerical value and the second unit of measure suitable for the second device.

16. The non-transitory machine readable medium of claim 14, wherein the code is configured to format the data packet to include the numerical value, the unit of measure, and a physical attribute type suitable for the first device or the second device.

17. The non-transitory machine readable medium of claim 16, wherein the code is configured to convert the data packet from a first data packet to a second data packet, wherein the first data packet comprises a first numerical value, the first unit of measure, and a first physical attribute type suitable for the first device, wherein the second data packet comprises a second numerical value, the second unit of measure, and a second physical attribute type suitable for the second device.

18. The non-transitory machine readable medium of claim 14, wherein the code is disposed on at least one of a processor, the first device, the second device, or any combination thereof.

19. The non-transitory machine readable medium of claim 14, wherein handling comprises formatting a raw data or the data packet to include the numerical value, the unit of measure, and a physical attribute type suitable for the first device or the second device.

20. A method, comprising:
handling a data packet that represents a physical attribute related to monitoring and/or control of at least one equipment over a period of time, wherein the data packet is exchanged between a first device operating in a first unit of measure and a second device operating in a second unit of measure, and the data packet includes a numerical value and a unit of measure suitable for the first device or the second device, wherein both the numerical value and the unit of measure selectively change with each data exchange.
